(19) United States
(12) Patent Application Publication
(10) Pub. No.: US 2011/0320223 A1
(43) Pub. Date: Dec. 29, 2011

(54) SYSTEM AND METHOD FOR ANALYSIS OF INSURANCE CLAIMS

(75) Inventors: Arthur Paul Drennan, III, West Granby, CT (US); Kevin Thomas Howard, Manchester, CT (US); Kyle M. Lee, Ellington, CT (US); Shannon Cathleen MacDonald, Cornelius, NC (US); Donald R. Pierce, Enfield, CT (US)

(73) Assignee: HARTFORD FIRE INSURANCE COMPANY, Hartford, CT (US)

(21) Appl. No.: 12/824,713

(22) Filed: Jun. 28, 2010

(51) Int. Cl. G06Q 40/00; G06F 17/30

(52) U.S. Cl. 705/4; 707/722; 707/E17.014

(57) ABSTRACT

A computer system for analyzing insurance claim data is configured to receive data relating to a current insurance claim from a client device; query a database for data relating to insurance claims similar to the current claim; receive from the database data relating to insurance claims responsive to the query; analyze the received data; generate a display of the analyzed received data and communicate the generated display to the client device for display on the client device. The display may include a value of recoveries within the time window as a proportion of initial demands for settled similar claims and a value of recoveries within the time window as a proportion of initial demands for arbitrated similar claims.

### FIELD OF INVENTION

The present invention relates to computer systems, and particularly to computer systems for analysis of insurance claims.

### BACKGROUND

After an automobile accident, drivers typically exchange information regarding their respective liability insurance coverage. At least one of the drivers involved, and in some cases, each of the drivers involved, contacts the insurance company for one of the other drivers and their own insurance company, and provides details of the accident and the damage to automobiles and any personal injuries. Each driver is typically looking to recover from another driver s insurance company, and their own insurance company, as compensation for damage to automobiles and personal injuries.

After the accident, the respective insurance companies may step into the shoes of the insured drivers, and attempt to recover from the other insurance company, depending on which of the drivers was at fault. This process of stepping into the shoes of the insured driver is known as subrogation. Once the insurance companies substitute themselves for their respective insureds, each insurance carrier will typically investigate the accident, such as by interviewing its insured and possibly other witnesses, reviewing police reports and having its representative, usually an adjuster, evaluate the damaged vehicle. Each of the insurance carriers has obtained the identity of the other carrier from the exchange of insurance information by the owners at the accident scene. At least one of the insurance carriers may then conclude that the other carrier is responsible for damages. For example, the owner may state that the other vehicle failed to stop at a stop sign and collided with the owner s vehicle. A representative of the insurance carrier will typically prepare a demand letter to the other carrier, demanding payment of a particular amount of money, with documentation of the grounds for liability and the amount of the damages.

The demand letter may result in a number of responses, including a counter offer, at a lower dollar amount, made by phone or letter. The representative of the demanding carrier generally relies on judgment and experience in deciding whether to accept the counteroffer. For example, the representative is of course aware that not accepting the counteroffer will result in a delay in obtaining payment. The representative may or may not have experience with the particular carrier and particular type of claim, and thus may have nothing more than a guess as to the likelihood that rejecting the counteroffer and proposing a new offer, or maintaining the original demand, is beneficial to the demanding carrier.

While the example of an automobile accident has been provided as an example, similar processes are followed in connection with other types of incidents giving rise to injury and damage that may be covered under insurance policies. Similar processes may be filed with respect to homeowners insurance, business liability insurance, and other types of insurance policies.

### SUMMARY

In one embodiment, a computer system for analyzing insurance claims is provided. The computer system may include a database having information as to insurance claims. The data associated with each of the claims may include identity of responding carrier, type of claim, dollar amount of claim, time until resolution, geographic area (such as state) where incident occurred, whether the claim was resolved by settlement, by arbitration, or by litigation, and other data. The system may be configured to receive data concerning a current claim, conduct one or more searches in the database for similar claims, and provide an output display providing data concerning similar claims. The display may include data relating to recovery on demands associated with a set of similar claims. The recovery data may include, for similar claims, by way of example, a proportion of funds recovered compared to amounts of demands within a time window or a proportion of claims resulting in a recovery within a time window. The recovery data may include data for claims against the same responding carrier resulting in a recovery within a time window and/or data for claims against a set of carriers resulting in a recovery within the time window. The display may include the proportions separately for recovery by settlement, arbitration and litigation. The system may be configured to display proportions for similar claims and/or all claims against the same responding carrier and against a set of carriers. The demanding carrier representative can observe the output from the system and use the results in deciding, for example, whether to accept a counter offer, to make a further counter offer, or to escalate a claim, such as to arbitration or litigation.

### BRIEF DESCRIPTION OF THE FIGURES

FIG. 1 is a schematic diagram of an environment for implementation of a method and system of the invention.

FIG. 2 is a schematic diagram of an exemplary computer network for implementation of a method and system of the invention.

FIG. 3 is a schematic diagram of an exemplary computer system for use in the exemplary computer network of FIG. 2.

FIG. 4 is a schematic diagram of an exemplary computer system for implementation of a method and system of the invention.

FIG. 5 is an exemplary process flow diagram of an exemplary method of the invention.

FIG. 6 is an exemplary process flow diagram of an exemplary method of the invention performed at a client device.

FIG. 7 is an exemplary screen display generated by an exemplary computer system of the invention.

FIG. 8 is a further exemplary screen display generated by an exemplary computer system of the invention.

FIG. 9 is a further exemplary screen display generated by an exemplary computer system of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for analyzing data related to insurance claims.

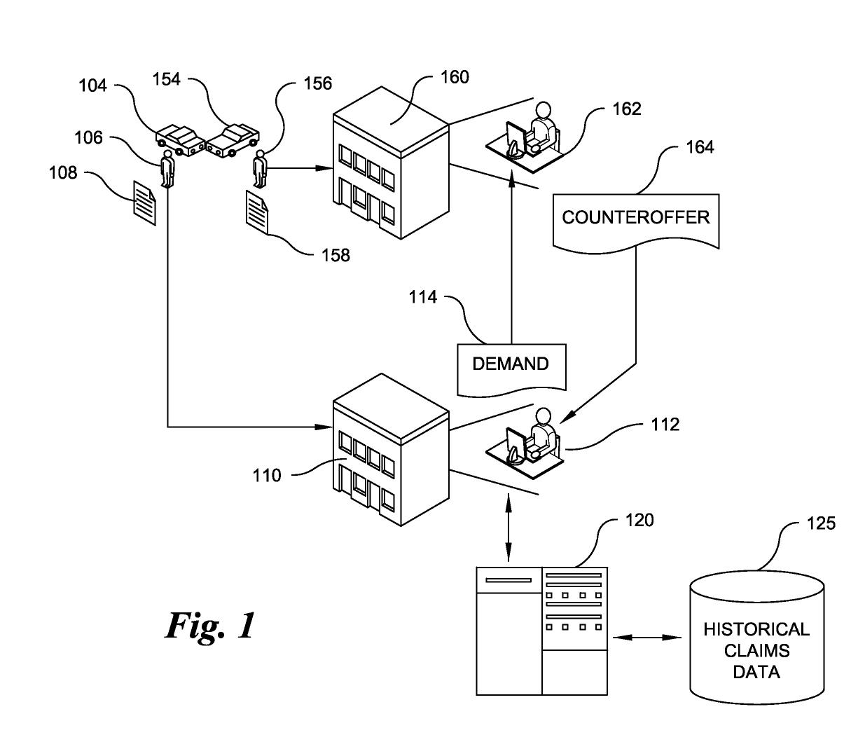

Referring now to FIG. 1, a high level view of an environment for implementation of a method and system that overcomes the problems encountered in the prior art is illustrated. The environment of FIG. 1 is based on an exemplary two vehicle automobile collision between vehicle 104 driven by driver 106 and vehicle 154 driven by driver 156. Driver 106 is insured under insurance policy 108 by insurance company 110. Driver 156 is insured under insurance policy 158 issued by insurance company 160. Driver 106 communicates information regarding the accident and damage to insurance company 110, which issued policy 108 to driver 106. Insurance company 110, after evaluating the information provided by driver 106, pays driver 106 suitable amounts per policy 108 for damage to vehicle 104, rental of a replacement vehicle while vehicle 104 is being repaired, and the like. Insurance company 110 obtains a right of subrogation as to driver 106 upon payment to driver 106.

Claims representative 112 of insurance company 110 reviews the information provided by driver 106, and any other available information, such as reports from an adjuster, a police report, and reports from body shops that performed the repairs on vehicle 104. Claims representative 112 then determines that driver 156 was at fault. For example, driver 106 may have stated that vehicle 154 drive by driver 156 failed to stop at a stop sign, and the police report and other evidence may be consistent with driver 156 being at fault. Claims representative 112 then prepares demand 114. Demand 114 states an amount that insurance company 110 demands from insurance company 160, and details the factors making up the demand, such as the charges of a body shop for repairs to vehicle 104 and the costs paid to driver 106, such as for reimbursement of rental car costs. Demand 114 is reviewed by claims representative 162 of insurance company 160. Claims representative 162 also consults available information, such as statements from its insured driver 156, police reports and the like. Claims representative 162 decides to send counteroffer 164 to insurance company 110. Counteroffer 164 includes an offer of a payment to insurance company 110, but in a lesser amount than the amount demanded in demand 114.

Claims representative 112 of insurance company 110 must then decide whether to accept counteroffer 164. Claims representative 112 employs a method and system of the invention to assist in making this decision. Claims representative 112 accesses, such as from a client device, server computer 120. Server computer is configured to receive data concerning claims, such as the claim embodied in demand 114. Data concerning claims may include the identity of the responding carrier, the type of claims (e.g., property damage, personal injury); the type of insurance policy (such as automotive, homeowners, business owners policy, and other types), the state in which the event giving rise to the claim occurred, and the amount of the demand. Server computer 120 then performs one or more queries in a database 125 of data concerning claims to identify claims that are similar. Similar claims may be identified employing multiple factors or data items. Similar claims may have identical data items, such as same claim type, same type of insurance policy, same state, or data points within a range, such as an amount of demand no more than a percentage or dollar figure higher or lower than the demand. Similar claims may be defined to have a number of identical data points. The search identifies a set of similar claims. The system may display a proportion or other calculation indicative of resolution of demands for similar claims. For example, the system may display a proportion of the value of recoveries compared to the value of demands made involving similar claims within a time window or similar claims settled within a time window when brought against the same responding carrier. The data used in the proportion may involve values or numbers of claims for any of similar claims brought against all carriers or against a set of similar or benchmark carriers. The system may also display proportions of claims and values of recoveries through arbitration and through litigation, separately, for one or more of the above options of similar claims, the same carrier, all carriers and a benchmark set of carriers, for example. The system may be configured to display proportions and other graphical representations of analyses of claim data, for all claims and for claims similar to the current claim, for settled, arbitrated and litigated claims, on a single screen or display.

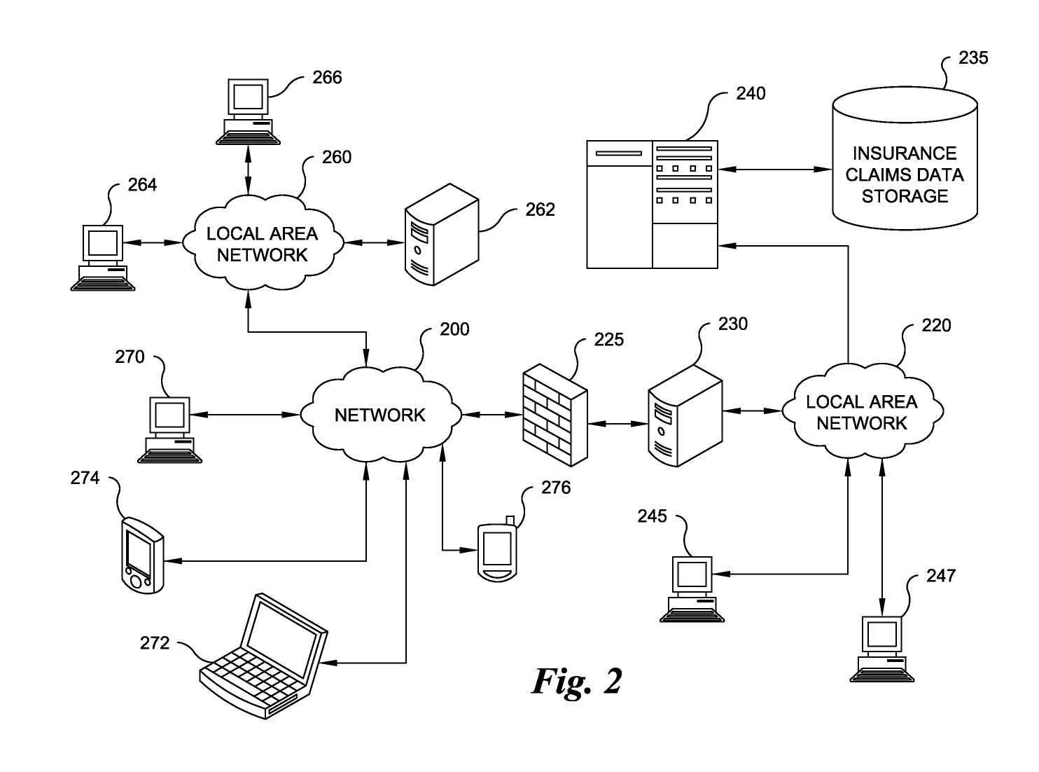

Referring to FIG. 2, an exemplary network configuration is shown. Network 200 connects various computer systems and devices. Network 200 may be or include any type of network, including a local area network (LAN), a wide area network (WAN), an intranet, the Internet, a public switched telephone network (PSTN) or other network. Network 200 may employ any suitable data protocols.

Various devices and networks may be in communication with network 200. In embodiments, client device 270, a desktop computer system, client device 272, a notebook computer system, and client device 274, a personal digital assistant, and client device 276, a smart phone, are in communication with network 200. Client devices 270, 272, 274 are merely exemplary. Local area network (LAN) 260 is an exemplary network of an entity such as an insurance carrier or an entity that provides claims management services on behalf of insurance carriers. LAN 260 has in communication therewith desktop computer systems 264, 266, and file server 262. File server may store data relating to one or more claims being processed by an insurance carrier or claims management services provider.

LAN 220 may be a network of an insurance company, by way of example. Firewall unit 225 may be configured to provide data security services with respect to systems and networks, LAN 220 and the devices in communication therewith. Firewall unit 225 may be a stand alone device including one or more processors, data storage devices, and input and output connections. Server 230 may serve as a front-end web server that formats and serves web pages to client devices running browser software. In an embodiment, a processor of server 230 may execute steps of a method of generating display data to prompt users at client devices to enter claim data, and to generate display data to present analyzed claim data to users at client devices. In an embodiment, server 230 may function as a web front-end for another device or system, such as server 240, which may execute steps of a method of conducting searches on databases of claim information stored in data storage devices, such as exemplary claims information data storage device 235. Server 230 may provide the functionality of a graphical user interface generation module discussed in greater detail herein. Server 240 may provide the functionality of one or more of the processing modules, data access modules and communication modules discussed in greater detail herein. The term module, as used herein, includes computer hardware, including processors and memory devices, having loaded program code causing the processor and other devices to perform particular functions. Server 240 may receive claim data from client devices via web server 230, perform searches on claims databases stored in data storage device 235 to identify similar claims, receive data concerning similar claims, store and analyze the received data, generate displays of the analyzed data, and provide the displays to web server 230 for communication to client devices for display. Local client devices 245, 247 may be workstations of users such as employees of an insurance company that maintains server 240 and claims data storage devices 235. Users employing local client devices 245, 247, may access server 240 via local area network 220. While local client devices 245, 247 are depicted as desktop personal computer systems, local client devices 245, 247 may be any suitable client device, including thin clients, smart phones, personal digital assistants, and other devices.

In embodiments, a network or data processing network, such as network 200, may be employed which may include a plurality of individual networks, such as a wireless network and a landline based network, each of which may include a plurality of servers, individual workstations or personal computers. Additionally, as those skilled in the art will appreciate, one or more LANs may be included where a LAN may include intelligent workstations coupled to a host processor. The networks may also include mainframe computers or servers, such as a gateway computer or application server. A gateway computer serves as a point of entry into each network. The gateway may be coupled to another network via one or more communications links. The gateway may also be directly coupled to one or more workstations using a communications link. The gateway computer may also be coupled to a storage device for storing information related to insurance claims. Further, the gateway may be directly or indirectly coupled to one or more workstations. Those skilled in the art will appreciate that the gateway computer may be located geographically remote from the network, and similarly, the workstations may be located geographically remote from the networks and/or network servers. The client devices or workstations may connect to the wireless network using a networking protocol such as the Transmission Control Protocol/Internet Protocol (“TCP/IP”) over a number of alternative connection media, such as cellular phone networks, radio frequency networks, satellite networks, etc. The wireless network may connect to the gateway using a network connection a such as TCP (Transmission Control Protocol) or UDP (User Datagram Protocol) over IP, X.25, Frame Relay, ISDN (Integrated Services Digital Network), PSTN (Public Switched Telephone Network), etc.

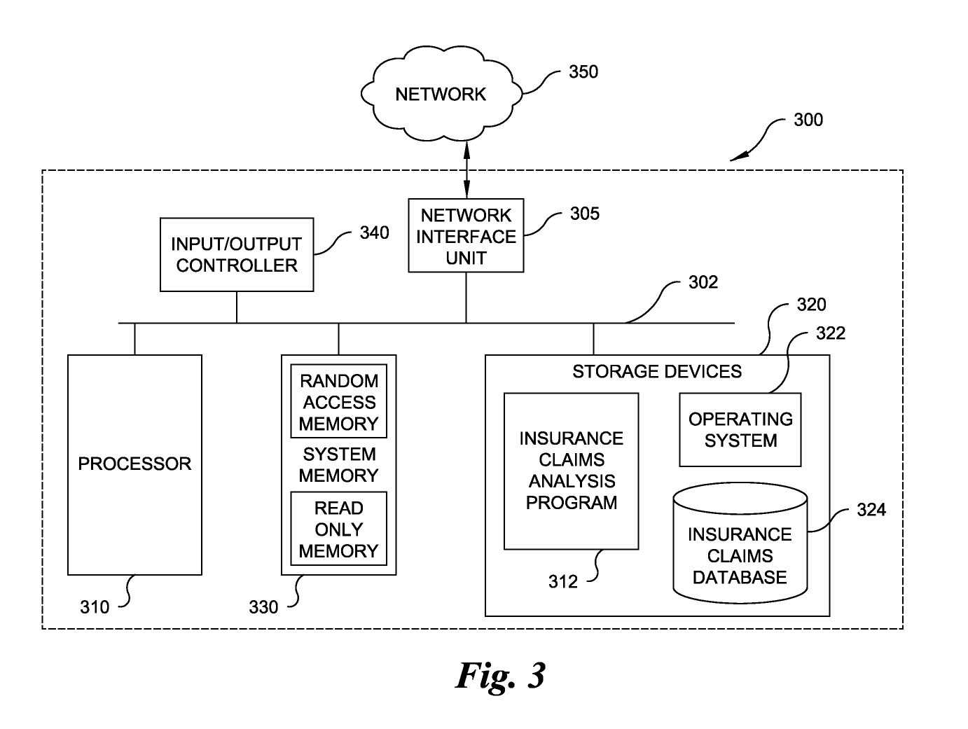

Referring to FIG. 3, an exemplary computer system 300 for use in an implementation of the invention will now be described. In computer system 300, processor 310 executes computer-readable instructions contained in programs such as insurance claims analysis application program 312, stored on non-transitory computer-readable media of data storage devices 320. The non-transitory computer-readable media of data storage devices 320 may include optical or magnetic disks, fixed disks with magnetic storage (hard drives), tapes accessed by tape drives, and other non-transitory computer-readable storage media. Processor 310 communicates, such as through bus 302 and/or other data channels, with network interface unit 305, system memory 330, storage devices 320 and input/output controller 325. Via input/output controller 325, processor 310 may receive data from user inputs such as pointing devices, touch screens, audio inputs and keyboards, and may provide data to outputs, such as data to video drivers for formatting on displays, and data to audio devices. Storage devices 320 are configured to exchange data with processor 310, and may store programs containing processor-executable instructions, and values of variables for use by such programs. Storage devices 320 may include local and network accessible mass storage devices. Storage devices 320 may include non-transitory computer-readable media for storing operating system 322 and mass storage devices such as insurance claims database 324 for storing data related to current and historical insurance and subrogation claims, such as responding carrier identity, type of damages (e.g., personal property, real property, personal injury), amount of demand, whether settled, arbitrated or litigated, amount of recovery, date of demand, date of recovery, and other data. In an embodiment, inputs may include user interfaces, including workstations having keyboards, touch screens, pointing devices such as mice, or other user input devices, connected via networked communications to processor 310. Network interface unit 305 may communicate via network 350 with remote sources of data, such as data concerning drivers licenses, insurance policy data, vehicle data, and real property data, and computer systems of other carriers, as well as computer systems of entities providing data, such as insurance adjusters, investigators, and body shops, and with systems for implementing instructions output by processor 310. Network 350 may be or include wired or wireless local area networks and wide area networks, and over communications between networks, including over the Internet. Any suitable data and communication protocols may be employed.

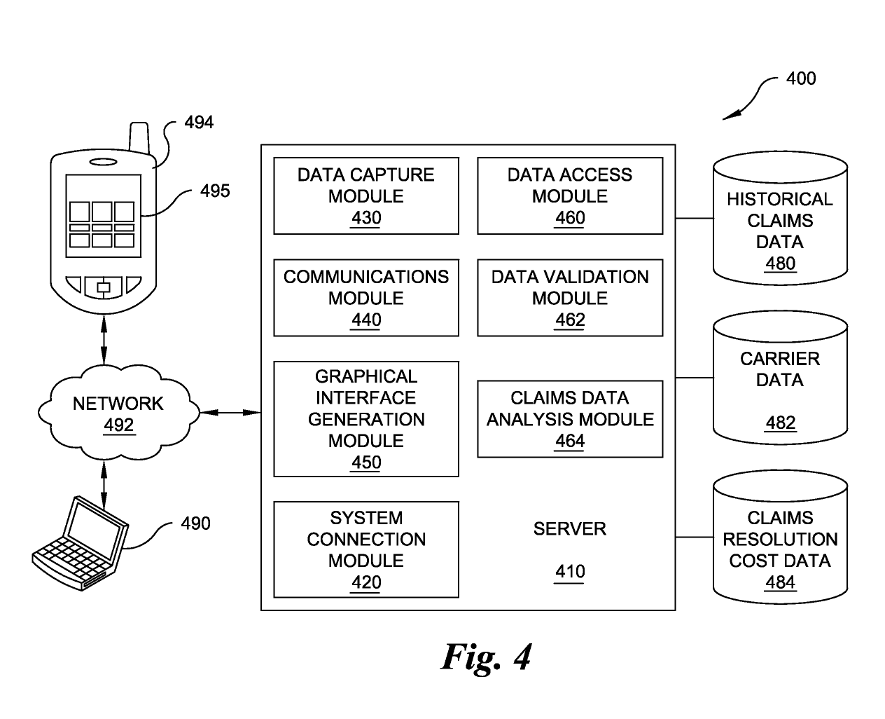

Referring now to FIG. 4, a system 400 for furnishing claims analysis data to a client device is shown. System 400 may operate to provide data to any suitable client device, including without limitation the exemplary client devices 490, 494, illustrated in FIG. 4. System 400 includes hardware server 410 which is configured to implement one or more modules. A user employing client device 490, 494 communicates with system 400 via network 492. Client devices 490, 494 may be granted access to system 400 by system connection module 420, which may verify credentials such as user identification and password. Data access module 460 is configured to, responsive to a request from a user device, access historical insurance claim data, data related to carriers, and cost data from a database, such as databases 480, 482, 484. The user may be a claims representative of a carrier, or an employee of an entity that provides claims management services to carriers.

Data access module 460 is configured to access data from databases 480, 482, 484, including data related to claims, such as type of claim, type of insurance policy, state and/or other geographic location of incident, identity of carriers involved, type of resolution, date of demand communicated to responding carrier, date of recovery, time to recovery, dollar amounts of demands and counter offers, dollar amounts of recoveries, and other data. In the embodiment, the claims data, carrier data and cost data are in separate databases 480, 482, 484. The separate databases may be separate logical databases on the same physical data storage device or devices, or may be maintained in separate physical data storage devices. In other embodiments, the data may be maintained in a single logical database, or in a different number of databases and distributed in two or more databases along logical divisions other than the divisions illustrated in FIG. 4. A single logical database may include data stored in one or more physical data storage devices. In an embodiment, the databases may be implemented in any suitable relational database management system, such as Oracle or Microsoft SQL server. In an embodiment, suitable SQL queries may be stored in software code in one or more memory devices by data access module 460 and accessed by data access module 460 in response to a user request for data, such as for data for claims similar to a current claim. In another embodiment, queries may be stored in databases 480, 482, 484, and may be accessed by data access module 460. Queries may be formulated, such as by a processing module or other module of server 410, and employed by data access module 460.

Data accessed by data access module 460 may be furnished to graphical user interface generation module 450. Graphical user interface generation module 450 may have associated therewith one or more templates for presentation of data accessed by data access module 460. Graphical user interface generation module 450 may populate a selected template with the accessed data and transmit the populated template for display on a client device. Graphical user interface generation module 450 may be configured to display on a single screen or display, value of recoveries for the demanding carrier, as a proportion of the total value of initial demands, within the time window, for similar claims and for a larger set of claims, and for settled, arbitrated and litigated claims, on a single screen or display. GUI generation module 450 may similarly be configured to display on a single screen or display alternative data, such as proportions of demands resolved by settlement, arbitration and litigation with a recovery for the demanding carrier, for differing sets of claims, such as similar claims and all claims.

GUI generation module 450 may be configured to display on a single screen: a value of recoveries within a time window as a proportion of initial demands for similar claims that have been settled and a value of recoveries within the time window as a proportion of initial demands for similar claims that have been arbitrated. GUI generation module 450 may be configured to display, on a single screen, a value of recoveries within a time window as a proportion of initial demands for similar claims that have been settled, a value of recoveries within the time window as a proportion of initial demands for similar claims that have been arbitrated, and a value of recoveries within the time window as a proportion of initial demands for similar claims that have been litigated. The GUI generation module 450 may be further configured to display a value of recoveries as a proportion of initial demands against time for time periods within the time window.

System connection module 420 provides authentication and data security services. System connection module 420 performs functions of authenticating users for access to a computer system for analysis of insurance claims. System connection module 420 also performs other firewall functions, such as identification and neutralizing of malicious code and other attacks. In an embodiment, a system connection module may be implemented on the server and perform functions of authenticating users and permitting connection to system components. In an embodiment, a system connection module may be implemented on a standalone device, in communication with the server and the network and physically interposed in a communications channel between the server and the network, the standalone device including one or more processors and memory devices storing code having instructions which, when executed by the one or more processors, causes the one or more processors to perform authentication and firewall functions.

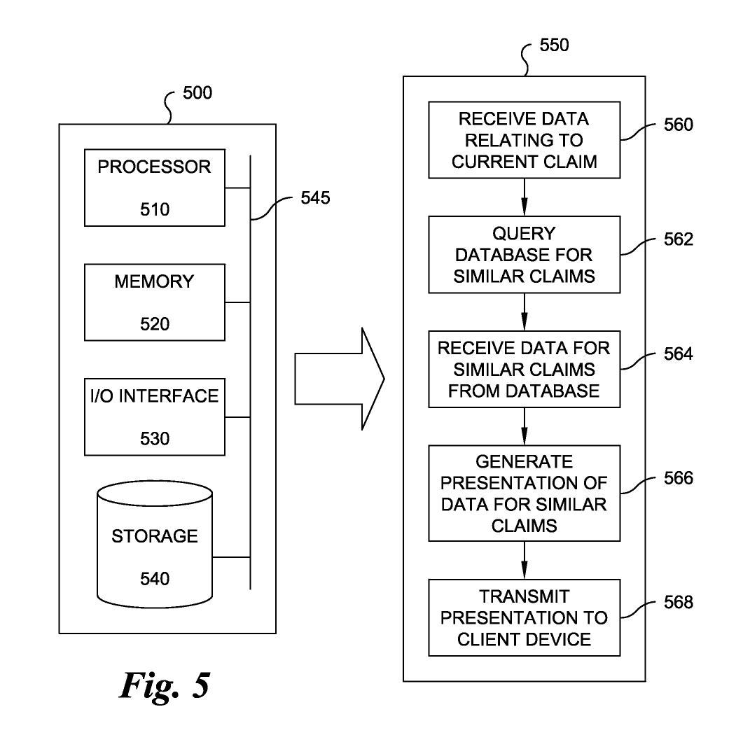

Referring now to FIG. 5, an exemplary process flow executed by a computer system is shown. Computer system 500 has processor 510 in communication, via bus 545, with local memory 520, input/output interface 530, and data storage 540. Instructions stored in memory, such as in data storage 540 and loaded into local memory 520, when executed by processor 510, cause processor 510 to execute the steps of process flow 550. Data storage 540 includes non-transitory computer-readable media. In process flow 550, data concerning a current claim is received 560. Data may be received via input/output interface 530, for example. Processor 510 queries a database, which may be implemented in local data storage 540 or in a data storage device accessed via input/output interface 530, for similar claims. Processor 510 may receive 564 data for similar claims from the database. The received dataset may be compared to a benchmark minimum number of similar claims. If the number of claims in the received dataset is below the benchmark minimum, then a new query may be formulated, bypassing one or more constraints in the prior query. For example, the initial query may include a first range of dollar values of demand, and the a subsequent query may include a second, expanded range of dollar values of demand, such as by changing one or both limits of dollar value constraint. Other factors, constraints or data items of an initial query may be removed or expanded in a subsequent query. For example, factors such as geographic region or state may be expanded, such as by including neighboring states or states otherwise tagged as similar, or by bypassing a state constraint. Any available factor may be expanded, removed, or remain the same in a subsequent query. The processor may dynamically change the query to select a group of similar claims of sufficient numbers to meet a benchmark minimum.

Upon receipt of search results including a sufficient number of similar claims, the processor may analyze the claims and generate 566 a presentation of the received and analyzed data concerning the similar claims. The analysis may include determining percentages of amounts recovered as a portion of amounts demanded within a time window from an initial demand, percentages of numbers of claims that result in a recovery within a time window from an initial demand, and other relevant data. The time window may be a fixed value, may be selected by the user within a range, or may be a value associated with a type of claim and stored in a look-up table, for example. Examples of time windows include 6 months, 8 months, 1 year, 2 years, and any other period in the range from 6 months to 2 years. The time window may be measured from events other than a first demand, such as an incident date, receipt of claim from an insured, or other events. The presentation may employ one or more templates stored in computer-readable media in the system and having fixed data elements and variable data elements depending on the results of the analysis. The results of the analysis, search results, and presentations may be stored permanently or permanently in one or more data storage devices. The processor may then transmit 568 the presentation for display on a client device.

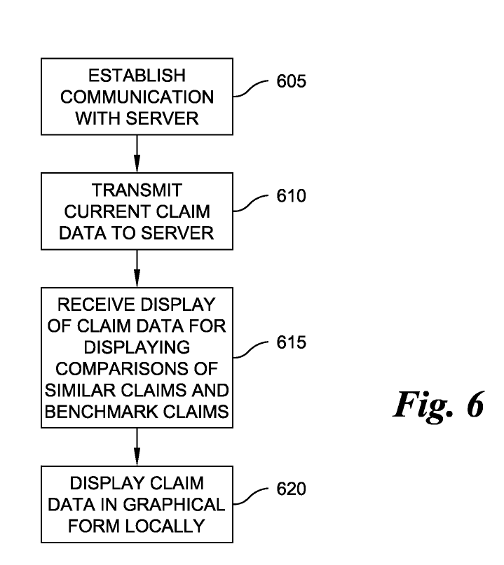

Referring to FIG. 6, a process flow diagram from a client device is shown. The client device establishes communication, such as through presentation of appropriate credentials, with a server. The client device transmits 610 data concerning the current claim over a network to a server. The data includes a responding carrier, type of claim and demand amount, and may include other information. The client device then receives 615 data indicative of a display of recovery-related data for similar claims, such as a comparison of proportions of amounts of demands recovered for similar claims and for a larger set of claims, such as all claims in the database, within a time window, comparison of proportions of demand values recovered for claims against a same carrier and compared to a benchmark set of carriers, over time. In the method, the particular data related to recoveries on demands based on insurance claims may be varied. The client device then displays 620 the data locally for the user on a display device.

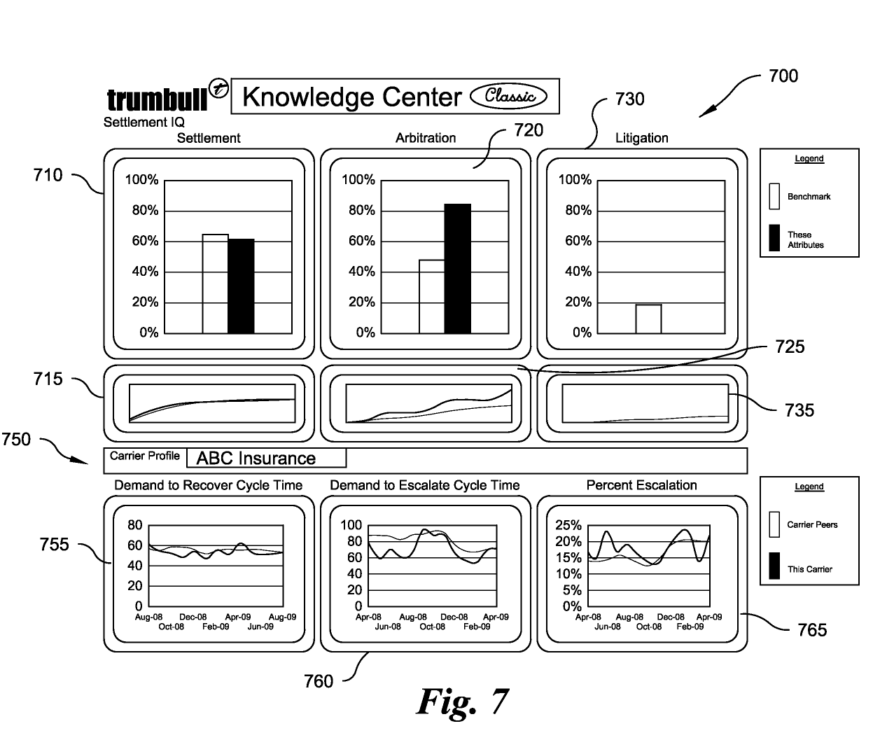

Referring to FIG. 7, an exemplary display 700 is shown responsive to input by a representative from a client device of a current claim. In recovery graph 710, statistics related to recoveries on similar claims by settlement within a time window are shown. In this embodiment, the statistics are provided in two subsets: one for a benchmark set of claims and one for a set of similar claims. The benchmark set may be all settled claims in general, all claims in general, all settled claims or all claims against the same carrier, all settled claims against similar carriers, or another set broader than a set of similar settled claims. The user will conclude that recovery by settlement for similar claims within the time window is generally the same as claims in general. Graph 715 shows amount of recoveries as a percentage of amounts of initial demands against time. The time may represent time from a date of an initial demand. The user can see that recoveries from settlements of claims increase quickly after the demand, and then level off. The statistics make it clear that a large proportion of the value of total demands for similar claims are available through settlement, and that settlement is successful within a relatively short time after the initial demand.

Graph 720 shows statistics for similar claims that are arbitrated. The value of recoveries from arbitration from a responding carrier within a time window as a proportion of the total amount of demands of arbitrated claims is shown. In this example, the percentage of value of demands that are recovered through arbitration within the time window is higher for similar claims than for a benchmark set of claims. A claims representative may conclude that arbitration may be a better option for this claim than for the typical claim. Graph 725 shows amounts recovered as a percentage of amount of demands over time in similar claims arbitrated and in a larger set, or benchmark set, of claims, such as all claims, arbitrated. It can be seen that the recovery through arbitration is initially very low for both similar claims and the benchmark set of claims. A visual comparison between graphs 715 and 725 is beneficial to the representative in seeing that recoveries through settlement are obtained more quickly than recoveries through arbitration. As the differential in recoveries over time between similar claims and the larger set of claims, with recoveries being higher for similar claims, can be seen to increase over time, the representative may conclude that as time elapses after a demand, escalating to arbitration is more likely to be beneficial.

Graph 730 shows statistics for similar claims that are litigated. The value of recoveries within the time window from litigated similar claims as a proportion of the value of initial demands of litigated claims is shown. In this example, only 20% of the value of demands for claims that are litigated in the set of benchmark claims is recovered within the time window, while no recovery is received within the time window for similar claims that are litigated. This result communicates the relatively slow time to recovery associated with litigating a claim, as compared to both settlement and arbitration. Graph 735 displays recoveries over time in similar claims and benchmark claims that are litigated. The user will perceive that litigating a claim delays recovery, and more so in claims similar to the current claim than in claims in general.

Carrier profile section 750 graphically displays data relating to the responding carrier and a benchmark set of carriers. The data for carrier profile section 750 may be data for claims similar to the current claim in an embodiment, or, in another embodiment, may include all claims. Profile section 750 displays time series data, and particularly data relating to changes in timing of recoveries in claims against the carrier and the benchmark carriers over time. Graph 755 displays an average time period from demand to recovery, in days, over a one year period of time. Graph 755 indicates no significant changes in either timing of recovery against the carrier or timing of recovery against the benchmark carriers. Graph 760 displays an average time period from demand to escalation, also against both the carrier and the benchmark, over the same one year period. Escalation refers to commencement of arbitration or litigation. By reviewing graph 760, the user may conclude that, in the benchmark set of carriers, the time from demand to escalation has decreased within the past several months. The data as to the particular carrier involves more fluctuations, but is also consistent with an overall decrease in time to escalation.

In other embodiments, other statistical measures of cycle time from demand to recovery and demand to escalation may be shown. For example, a median time from demand to recover and a median time from demand to escalation may be shown. The start of the time period may also be different from the date of the demand in other embodiments. For example, the date of receipt of a claim from an insured or a date that a claim is assigned to a representative may be the start of the period in an embodiment.

Graph 765 displays a percentage of claims against a carrier that are escalated against time over a one year period, both for the current carrier and for a benchmark set of carriers. The carrier s likelihood to arbitrate can be appreciated from this display. The claims representative may conclude that claims should be escalated to arbitration more quickly than otherwise against a carrier that arbitrates more claims than the benchmark, and has a greater likelihood of arbitrated claims resulting in recovery in the same time window than the benchmark.

A benchmark set of carriers may be selected based on factors such as numbers of claims handled by the carrier, dollar value of claims paid, or external information, such as published data regarding coverage and the like. Searches of one or more databases of carrier data may be performed in connection with determining a benchmark set of carriers for each carrier. Benchmark sets of carriers may be periodically determined algorithmically and stored in look up tables that are accessed when a request for data is received by the system. Benchmark sets of carriers may be determined by searches of carrier data in real time responsive to each request for data concerning a current claim.

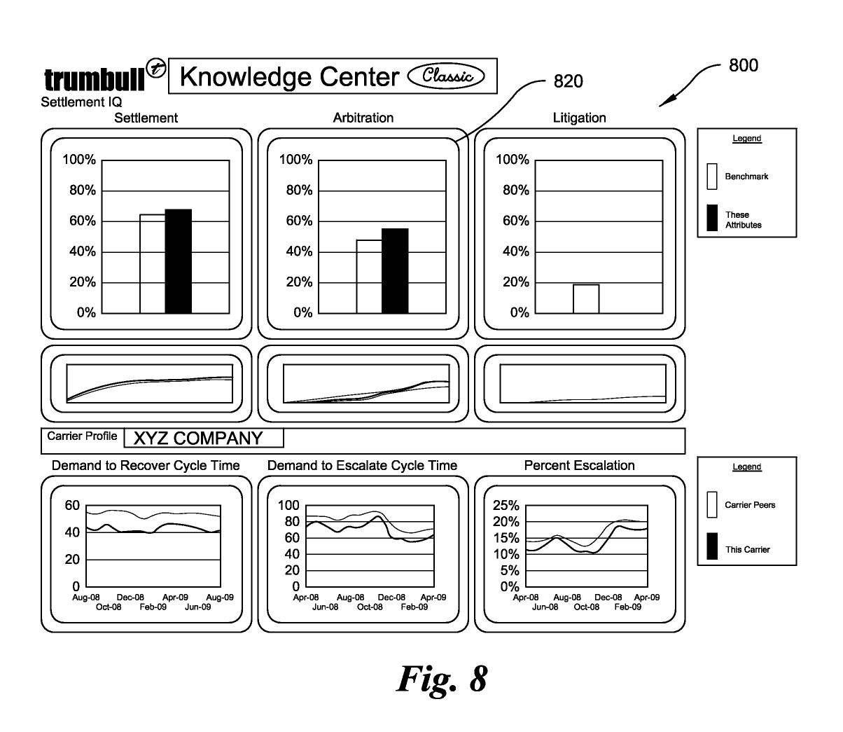

Referring to FIG. 8, display 800 displays the same type of analyzed insurance claim data as display 700, but for a different claim and a different carrier. Graph 820 shows, for example, that the results of arbitration for similar claims are fairly close to the results for broader benchmark set of claims.

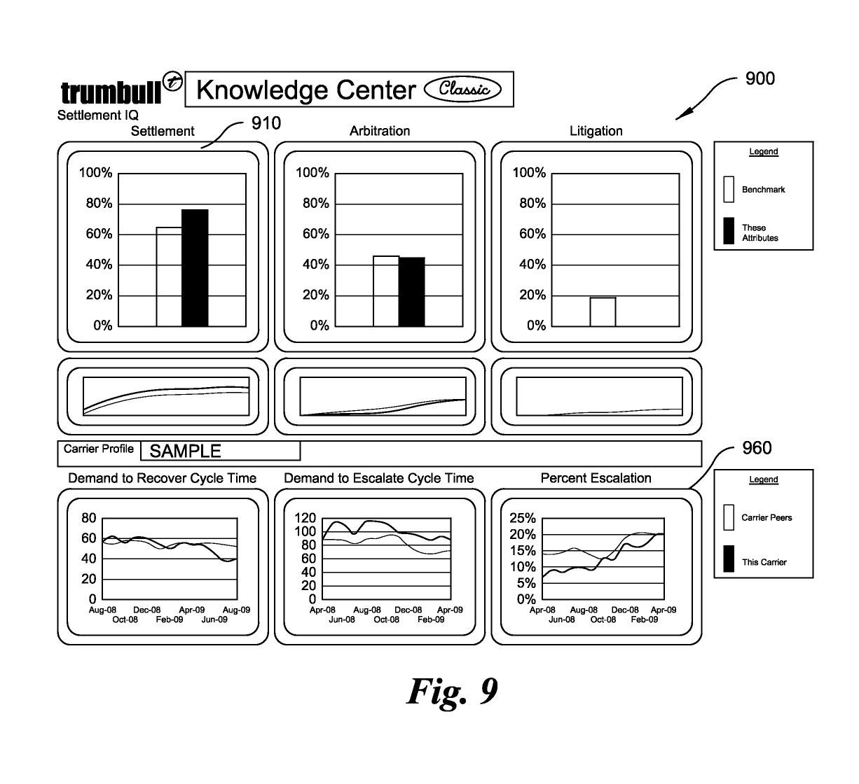

Referring to FIG. 9, display 900 displays the same type of analyzed insurance claim data as displays 700 and 800, but for a different claim and a different carrier. Graph 910 indicates to a user that settlement is more likely to result in a recovery within the time frame with this claim than with claims in general. The time series data, such as graph 960, suggest to a user that this carrier has recently been escalating cases to arbitration or litigation more frequently than previously, such that the likelihood of settlement may be less than for claims against this carrier that the user may have handled in the past.

Other types of comparisons are possible, such as comparisons of similar claims against the same carrier to similar claims against a benchmark set of carriers.

In an embodiment, the display may include a graph showing a carrying cost of delay in settlement or other resolution against time. The display may include a display of recoveries as a percentage of demands adjusted for carrying costs. The display may also include other graphical representations of the carrying cost.

In an embodiment, a display may be presented, such as for use by a manager of claims representatives, that compares a particular claims representative s performance to a benchmark set of claims representatives for similar claims. Factors such as percentage of cases settled within a time window, percentage of total demands recovered within a time window, percentage of cases arbitrated within a time window, and other comparisons, for a given claims representative and against a benchmark set of claims representatives, may be presented. The data may be presented for all claims of a claims representative and the benchmark set, or limited to sets of claims having similar characteristics. The manager may be able to select queries to compare performance of a claims representative on selected sets of claims against a benchmark set of representatives or compare performance of a claims representative on different sets of claims, such as to assess which types of claims are better handled by a particular claims representative.

Systems and methods of the present invention may be employed by a single carrier, using data obtained from its own experience as a demanding carrier and made available to its own claim representatives. Systems and methods of the present invention may be employed by a carrier using data obtained from a third party regarding experience of multiple carriers as demanding carriers. Systems and methods of the present invention may be employed by a firm that provides claims resolution services to multiple carriers using data obtained from the firm s experience in providing services for multiple carriers as demanding carriers.

Systems and methods of the present invention may be applied to experiences against entities other than carriers. For example, the systems and methods may be applied to litigated claims against attorneys and law firms. Proportions of cases settled within a time window and proportions of cases tried with a recovery within a time window may be displayed. Benchmarks may be other attorneys or law firms with similar numbers of cases in a time frame, all other attorneys or law firms within a particular state or particular county or other venue, by way of example.

Embodiments of the present invention are operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by a processor executing instructions contained in programs which may be stored in a storage medium, such as a magnetic or optical storage medium. The instructions may, when executed by a processor, cause the processor to execute algorithms disclosed in association with each step. It will be appreciated that any of the steps in the methods in accordance with the invention described herein may be so implemented.

An exemplary advantage of a system and method in accordance with an embodiment is that claims representatives can readily compare a current claim to similar claims, with information regarding progression of claims over time. A further exemplary advantage is that the claims representative can view claims for the same carrier, so that patterns of carrier behavior can be observed.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for analyzing insurance claims, comprising:
a system access module configured to authenticate a user from a client device;
a communication module configured to receive from the client device data relating to a current insurance claim;
a data access module configured to access from a database data relating to insurance claims;
a processing module configured to, based on the received data relating to the current insurance claim, formulate a query for use by the data access module in identifying claims similar to the current claim;
a graphical user interface generation module configured to provide, for display on the client device: data related to recoveries for similar claims compared to data related to recoveries for a broader set of claims, within a time window; and
a processor configured to execute instructions furnished by each of the modules.

2. The computer system of claim 1, wherein the current claim relates to an automotive collision.

3. The computer system of claim 1, wherein the GUI generation module is further configured to display on a single screen a value of recoveries within the time window as a proportion of initial demands for settled similar claims and a value of recoveries within the time window as a proportion of initial demands for arbitrated similar claims.

4. The computer system of claim 3, wherein the GUI generation module is further configured to display on the single screen a value of recoveries within the time window as a proportion of initial demands for litigated similar claims.

5. The computer system of claim 1, wherein the similar claims comprise claims having similarity in a plurality of factors, including responding carrier, type of claim and dollar value of claim.

6. The computer system of claim 1, wherein the time window is user-selected.

7. The computer system of claim 1, wherein the GUI interface generation module is further configured to display a value of recoveries as a proportion of initial demands against time for time periods within the time window.

8. The computer system of claim 1, wherein the GUI interface generation module is further configured to display a comparison of time to recovery for a responding carrier and for benchmark carriers over time.

9. A computer system for analyzing insurance claim data, comprising:
a hardware server in communication with a network;
a data storage device in communication with the hardware server;
the hardware server being configured to:
receive data relating to a current insurance claim from a client device over the network;
query a database on the data storage device for data relating to insurance claims similar to the current claim;
receive from the database data relating to insurance claims responsive to the query;
analyze the received data;
generate displays of the analyzed received data and communicate the generated displays over the network for display by the client device.

10. The computer system of claim 9, wherein the current claim relates to real property damage.

11. The computer system of claim 9, wherein the generated display includes a on a single screen a value of recoveries within the time window as a proportion of initial demands for settled similar claims and a value of recoveries within the time window as a proportion of initial demands for arbitrated similar claims.

12. The computer system of claim 11, wherein the generated display further includes on the single screen a value of recoveries within the time window as a proportion of initial demands for litigated similar claims.

13. The computer system of claim 11, wherein the generated display further includes on the single screen a value of recoveries within the time window as a proportion of initial demands for a broader benchmark set of arbitrated claims.

14. The computer system of claim 9, wherein the time window is user-selected.

15. The computer system of claim 9, wherein the generated display further includes a time to recovery for demands against the responding carrier over time and a time to recovery for demands against a benchmark set of carriers over time.

16. The computer system of claim 9, wherein the generated display further includes a comparison of time to escalation to arbitration or litigation for a responding carrier and for benchmark carriers over time.

17. The computer system of claim 9, wherein the received data includes a responding law firm, and the generated display includes data relating to proportions of cases settled by the responding law firm within a time window.

18. A computer-implemented method for analyzing insurance claims, comprising:
receiving by a hardware server data relating to a current insurance claim from a client device over a network;
querying by the hardware server a database having data stored on a data storage device in communication with the hardware server for data relating to insurance claims similar to the current claim;
receiving by the hardware server from the database data relating to insurance claims responsive to the query;
analyzing by the hardware server the received data;
generating by the hardware server a display of the analyzed received data and
communicating by the hardware server the generated displays over the network for display by the client device.

19. The computer-implemented method of claim 18, wherein the received data includes claim amount, claim type, claim state, and responding carrier.

20. The computer-implemented method of claim 18, wherein the generating includes generating a display including on a single screen a value of recoveries within a time window as a proportion of initial demands for settled similar claims and a value of recoveries within the time window as a proportion of initial demands for arbitrated similar claims.

21. The computer-implemented method of claim 20, wherein the generated display further includes on the single screen a value of recoveries within the time window as a proportion of initial demands for litigated similar claims.

22. The computer-implemented method of claim 20, wherein the generated display further includes a value of recoveries within the time window as a proportion of a value of initial demands for a benchmark set of arbitrated claims.

23. The computer-implemented method of claim 20 wherein the generated display further includes a time series display of times to recovery for demands made against a same responding carrier as a responding carrier of the current claim.

24. The computer-implemented method of claim 20, wherein the generated display further includes a comparison of time to recovery for a responding carrier and for a benchmark set of carriers over time.

25. A computer-implemented method for displaying data related to an insurance claim, comprising:
establishing by a client device, in communication with a network, communication with a hardware server over the network;
furnishing by the client device to the hardware server, via the network, data relating to a current insurance claim, the data including a demanded amount and a responding carrier;
receiving by the client device from the hardware server via the network data indicative of a graphical display of analyzed data relating to the current insurance claim; and
displaying by the client device the graphical display.

26. The computer-implemented method of claim 25, wherein the graphical display includes a value of recoveries within a time window as a proportion of initial demands for settled similar claims and a value of recoveries within the time window as a proportion of initial demands for arbitrated similar claims.

27. The computer-implemented method of claim 26, wherein the graphical display further includes a value of recoveries within the time window as a proportion of initial demands for litigated similar claims.

28. A non-transitory computer-readable medium having stored thereon computer-readable instructions, which instructions, when executed by a processor, cause the processor to:
receive data relating to a current insurance claim from a client device;
query a database for data relating to insurance claims similar to the current claim;
receive from the database data relating to insurance claims responsive to the query;
analyze the received data;
generate a display of the analyzed received data; and
communicate the generated display to the client device.

29. The non-transitory computer-readable medium of claim 28, wherein the generated display includes a value of recoveries within a time window as a proportion of initial demands for settled similar claims and a value of recoveries within the time window as a proportion of initial demands for a benchmark set of settled claims.

30. The non-transitory computer-readable medium of claim 29, wherein the generated display further includes a value of recoveries within the time window as a proportion of initial demands for arbitrated similar claims and a value of recoveries within the time window as a proportion of initial demands for a benchmark set of arbitrated claims.
